(19) United States
(12) Patent Application Publication
(10) Pub. No.: US 2001/0052980 A1
(43) Pub. Date: Dec. 20, 2001

(54) Spectroscope for measuring spectral distribution

(76) Inventor: Akifumi Tada, Gotenba-shi (JP)

Correspondence Address: DELLETT AND WALTERS, 310 S.W. FOURTH AVENUE, SUITE 1101, PORTLAND, OR, 97204, US

(21) Appl. No.: 09/812,473

(22) Filed: Mar. 19, 2001

(30) Foreign Application Priority Data
Mar. 22, 2000 (JP) 2000-079643

(51) Int. Cl. G01J 3/18; G01J 3/36

(52) U.S. Cl. 356/328

(57) ABSTRACT

A compact and high-performance spectroscope capable of providing a resolution of 0.1 pm or less as in the case of a large-sized spectroscope with an increased focal length and suitable for measuring the spectral distribution of an excimer laser beam. A collimating optical system collimates light under measurement passing through an entrance slit. The collimated light is incident on a diffraction grating and diffracted at angles differing depending on wavelengths. An imaging optical system focuses a beam of light diffracted by the diffraction grating. An exit slit or a light distribution detector is placed in a focal plane of the imaging optical system. A beam diameter-expanding optical system is placed at least between the collimating optical system and the diffraction grating to expand the diameter of the beam of light collimated by the collimating optical system at least in the direction of dispersion of the diffraction grating.

### BACKGROUND OF THE INVENTION

1. Field of the Invention

The present invention relates to spectroscopes for measuring a spectral distribution. More particularly, the present invention relates to a compact, high-resolution spectroscope designed specifically for measuring the spectral distribution of a laser beam.

2. Discussion of Related Art

In excimer lasers for use in semiconductor lithography, e.g. ArF excimer lasers, it is demanded that the spectral linewidth be 0.6 pm or less in terms of the full width at half maximum, and the integral spectrum width at 95% energy integral be 1.5 pm or less. To measure such a spectral waveform, a spectroscope having a resolution of 0.1 pm or less is needed.

As a spectroscope for measuring such narrow-band excimer laser light, a multi-pass spectroscope is proposed in Japanese Patent Application Unexamined Publication (KOKAI) No. Hei 11-132848 (U.S. Pat. No. 5,835,210). In the proposed spectroscope, a laser beam is made incident on the same diffraction grating a plural number of times to improve resolution.

Incidentally, conventional commercially available diffraction grating spectroscopes have low resolution. In Jobin Yvon THR1500, for example, the resolution is as low as 1.0 pm at a focal length of 3 m. The resolution Δλ of the spectroscope is expressed by

Δλ={d·cosβ/(m·f)}Δx (1)

where:

d is the groove pitch of the diffraction grating;

β is the angle of diffraction;

m is the order of diffraction of the diffraction grating;

f is the focal length of the collimating optical system (=the focal length of the imaging optical system); and

Δx is the exit slit width.

[e.g. see “Optronics” (1988) No. 3, pp. 124-130]

It will be understood from the above relationship that in order to increase the resolution of the above-described commercially available spectroscope to a level of 0.1 pm, it is necessary to increase the focal length f to 30 m, that is, by 10 times. This causes the spectroscope to become an unfavorably large-scale system. The same is the case with the above-described multi-pass spectroscope.

The resolution of the spectroscope may be increased by increasing the diffraction angle β of the diffraction grating to 700 or more. However, in conventional holographic diffraction gratings, the intensity of diffracted light is small, i.e. 20% or less. Therefore, the S/N ratio is unfavorably reduced if the diffraction angle β is increased. For this reason, the practical working range angle is limited to 60° or less.

### SUMMARY OF THE INVENTION

The present invention was made in view of the above-described problems with the prior art.

Accordingly, an object of the present invention is to provide a compact and high-performance spectroscope capable of providing a resolution of 0.1 pm or less as in the case of a large-sized spectroscope with an increased focal length by addition of a simple arrangement and suitable for measuring the spectral distribution of an excimer laser beam.

To attain the above-described object, the present invention provides a spectroscope for measuring a spectral distribution including an entrance slit and a collimating optical system for collimating light under measurement passing through the entrance slit. The spectroscope further includes a diffraction grating on which the light collimated by the collimating optical system is incident and which diffracts the light at angles of diffraction differing depending on wavelengths. An imaging optical system focuses a beam of light diffracted by the diffraction grating. An exit slit or a light distribution detector is placed in a focal plane of the imaging optical system. In the present invention, the diffraction grating is a reflection type diffraction grating. The collimating optical system also serves as the imaging optical system. A beam diameter-expanding optical system is placed at least between the collimating optical system and the diffraction grating to expand the diameter of the beam of light collimated by the collimating optical system at least in the direction of dispersion of the diffraction grating.

In this case, it is desirable that the beam diameter-expanding optical system be formed from one or a plurality of magnifying prisms.

In particular, when the beam diameter-expanding optical system is formed from a plurality of magnifying prisms, it is desirable that all the magnifying prisms be positioned to face in the same direction, and the diffraction grating be mounted in a near-Littrow configuration so that one end of the diffraction grating is closer to the apex angle side of each magnifying prism.

It is also desirable that the following condition be satisfied:

15(m)<f×M (2)

where f is the focal length of the collimating optical system, and M is the beam diameter magnifying power of the beam diameter-expanding optical system.

In this case, it is desirable that the diffraction grating be an echelle grating.

It is also desirable that the diffraction grating be a near-Littrow mounted echelle grating, and the imaging optical system be formed from three magnifying prisms, and further that the angle of incidence on each magnifying prism be in the range of from 72° to 76°, and the angle of emergence therefrom be 0° or in the vicinity of 0°.

Further, it is desirable that the light distribution detector be a linear sensor having micro photodetector elements arranged linearly or a two-dimensional array sensor having micro photodetector elements arranged in a planar configuration.

Further, it is desirable that a deflection mirror be placed in front of the light distribution detector.

In the present invention, a beam diameter-expanding optical system is placed at least between the collimating optical system and the diffraction grating to expand the diameter of the beam of light collimated by the collimating optical system at least in the direction of dispersion of the diffraction grating. Therefore, it is possible to obtain the same effect as that produced when the focal length of the collimating optical system increases by an amount corresponding to the beam diameter magnifying power of the beam diameter-expanding optical system, without increasing the focal length of the collimating optical system. Thus, the resolution can be improved to an extent corresponding to the beam diameter magnifying power. Accordingly, it becomes possible to realize a high-resolution spectroscope with a size approximately equal to that of the conventional apparatus without upsizing the system configuration. If an echelle grating is used as the diffraction grating, it is possible to carry out measurement with a high S/N ratio because the intensity of light is 40% or more even at a diffraction angle of 70° or more.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

The attached sole figure is a diagram showing the arrangement and optical path of a spectroscope for measuring a spectral distribution according to an embodiment of the present invention.

### DESCRIPTION OF THE PREFERRED EMBODIMENTS

The spectroscope for measuring a spectral distribution according to the present invention will be described below on the basis of an embodiment thereof.

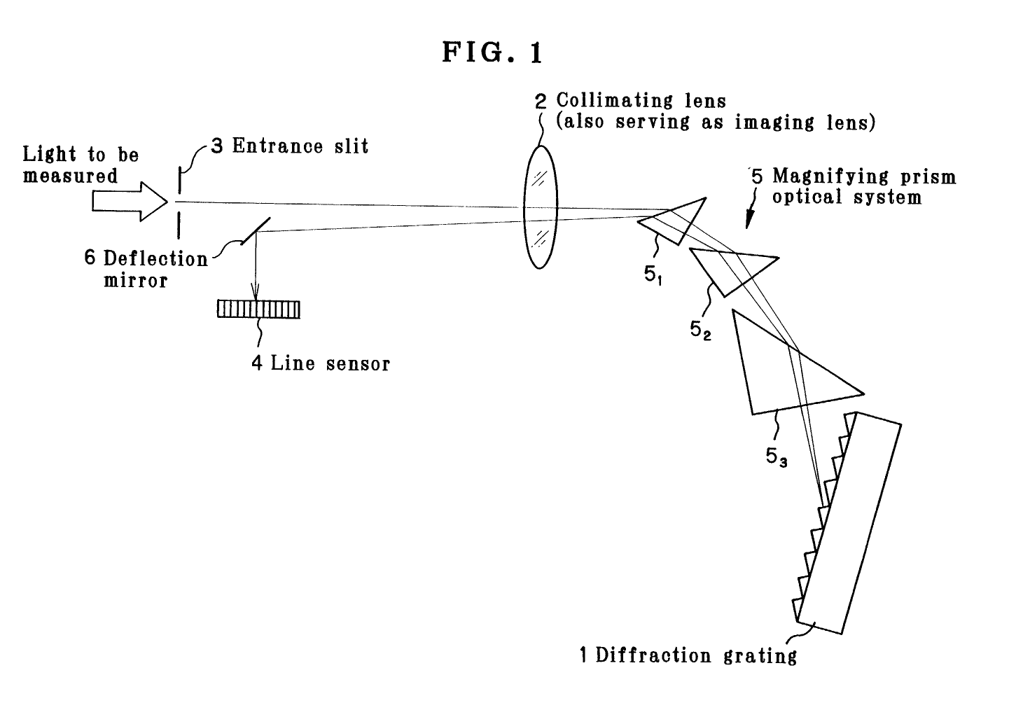

FIG. 1 is a diagram showing the arrangement and optical path of a spectroscope for measuring a spectral distribution according to the embodiment. In the figure, a reflection type diffraction grating 1 serves as a dispersing optical element. The diffraction grating 1 is mounted in a near-Littrow configuration using an echelle grating. The diffraction grating 1 is disposed in such a manner that the blazed grating grooves extend perpendicularly to the plane of the figure. A collimating lens 2 also serves as an imaging lens. Reference numeral 3 denotes an entrance slit. A line sensor 4 detects a dispersed spectrum and converts it into an electric signal. A magnifying prism optical system 5 including three magnifying prisms 5₁ to 5₃ is placed in the optical path between the collimating lens (imaging lens) 2 and the diffraction grating 1. Each of the magnifying prisms 5₁ to 5₃ is a deviation prism arranged so that a parallel beam of light from the collimating lens 2 is obliquely incident on one surface thereof and emerges normally from a surface thereof that faces the entrance surface across the apex angle, thereby expanding the beam diameter in the direction of the deviation angle. The three magnifying prisms 5₁ to 5₃ are cascaded to expand the beam diameter in the plane of the figure of light under measurement incident on the diffraction grating 1 from the collimating lens 2.

As shown in FIG. 1, the diffraction grating 1, the collimating lens (imaging lens) 2, the entrance slit 3, the line sensor 4 and the magnifying prism optical system 5 are arranged so that the entrance slit 3 is coincident with the front focal point of the collimating lens (imaging lens) 2. The magnifying prism optical system 5 is arranged so that light under measurement formed into a parallel light beam through the collimating lens 2 is incident on the near-Littrow mounted diffraction grating 1 after the beam diameter in the plane of the figure has been expanded, and that the desired higher-order diffracted light from the diffraction grating 1 is incident on the imaging lens 2 after the beam diameter thereof has been reduced. The line sensor 4 is placed at a position where diffracted light (dispersed light) is focused by the imaging lens 2 (i.e. the front focal plane of the collimating lens 2). To prevent interference between the entrance slit 3 and the line sensor 4, a deflection mirror 6 is interposed between the imaging lens 2 and the line sensor 4 so as to deflect the diffracted light focused by the imaging lens 2.

By virtue of the above-described arrangement, light under measurement generated from an ArF excimer laser apparatus, for example, enters the spectroscope through the entrance slit 3 and is collimated by the collimating lens 2 into a collimated beam. The collimated beam is incident on the near-Littrow mounted diffraction grating 1 after the beam diameter in the plane of the figure has been expanded by the magnifying prism optical system 5. The incident beam is diffracted by the near-Littrow mounted diffraction grating 1 in a direction approximately opposite to the incidence direction at angles of diffraction differing depending on wavelengths. The diffracted beam passes through the magnifying prism optical system 5 again approximately in the reverse direction. Consequently, the beam diameter in the plane of the figure is reduced. Thereafter, the diffracted beam is incident on the detection surface of the line sensor 4 through the imaging lens 2 while being dispersed for each wavelength. Thus, the spectral distribution of the light under measurement is detected.

The operation of the magnifying prism optical system 5 will be described below. Because the entrance slit 3 has a width, the light beam collimated by the collimating lens 2 deviates from parallel light by a small angle corresponding to the width. The reason why the resolution Δλ is in inverse proportion to the focal length f of the collimating lens 2 in the above-described equation (1) is that the small angle by which the collimated beam deviates from parallel light is in inverse proportion to the focal length f of the collimating lens 2. Accordingly, the resolution Δλ can be improved by increasing the focal length f of the collimating lens 2 to thereby reduce the small angle by which the collimated beam deviates from parallel light, as has been stated above in regard to the prior art.

In this regard, if a beam diameter-expanding optical system such as the magnifying prism optical system 5 is inserted between the collimating lens 2 and the diffraction grating 1 as shown in FIG. 1, the angle by which the collimated beam incident on the diffraction grating 1 deviates from parallel light reduces to 1/M, where M is the beam diameter magnifying power of the beam diameter-expanding optical system, even when the focal length of the collimating lens 2 is the same. In other words, it is possible to obtain the same effect as that produced by increasing the focal length of the collimating lens 2 by M times in an arrangement where such a beam diameter-expanding optical system is not inserted.

This is the basic principle of the present invention. Therefore, it is unnecessary to increase the focal length f of the collimating lens 2 by 10 times as in the past when the resolution needs to be raised to a level of 0.1 pm. Accordingly, the spectroscope can be constructed in a compact form.

A specific numerical example will be shown below.

The wavelength range of light to be measured:

192.9 nm to 193.9 nm

The focal length f of the collimating lens 2:

1 m

The slit width of the entrance slit 3:

25 μm

The pitch of detecting elements of the line sensor 4:

25 μm

The magnifying prism optical system 5:

Material of the magnifying prisms 5₁ to 5₃:

Calcium fluoride

The angle of incidence on the magnifying prisms 5₁ to 5₃:

73°

The angle of emergence from the magnifying prisms 5₁ to 5₃:

0°

The apex angle of the magnifying prisms 51 to 53:

39.5°

The number of magnifying prisms 5₁ to 5₃:

3

The overall magnifying power M:

18.3×

The magnifying power of each of the magnifying prisms 5₁ to 5₃:

2.64×

The diffraction grating 1:

The number of grooves:

82.8 grooves/mm

76°

Blaze angle:

Configuration:

Near-Littrow mounting

(incidence angle≈diffraction angle),

incidence angle≈blaze angle

Resolution:

Spectroscope with the magnifying prism optical system 5 (present invention):

about 0.07 pm

Spectroscope without the magnifying prism optical system 5 (prior art):

about 1.20 pm

The spectral distribution of ArF excimer laser light of wavelength 193.4 nm can be measured at a resolution of about 0.07 pm in the measurement light wavelength range of 192.9 nm to 193.9 nm by using the spectroscope in which the focal length f of the collimating lens 2 is 1 m and which uses a magnifying prism optical system 5 including three magnifying prisms 5₁ to 5₃ made of calcium fluoride and having an overall beam diameter magnifying power M of 18.3×as stated above.

In the above-described embodiment, a magnifying prism optical system 5 including three magnifying prisms 5₁ to 5₃ is used as a beam diameter-expanding optical system. However, the number of magnifying prisms 5₁ to 5₃ is not necessarily limited to three but may be one or a plural number besides three. Further, in FIG. 1, all the three magnifying prisms are positioned to face in the same direction, and the diffraction grating 1 is mounted in a near-Littrow configuration so that one end of the diffraction grating 1 is closer to the apex angle side of each prism. However, the present invention is not necessarily limited to the described arrangement. It should be noted, however, that the arrangement shown in FIG. 1 allows the utilization of the dispersing action of the magnifying prisms 5₁ to 5₃ in addition to the magnifying action thereof. Accordingly, the spectral distribution measuring spectroscope is further improved in performance by additive effects obtained by combining the dispersing action of the magnifying prisms 5₁ to 5₃ with the dispersing action of the diffraction grating 1. Further, the magnifying prism optical system 5 may be replaced with a telephoto lens system formed from a negative or positive lens and a positive lens placed in confocal relation to the negative or positive lens. It is also possible to use a cylindrical telephoto lens system in place of the magnifying prism optical system 5. The cylindrical telephoto lens system is formed from a negative or positive cylindrical lens having a power only in a direction perpendicular to the groove direction of the diffraction grating 1 and a positive cylindrical lens placed in confocal relation to the negative or positive cylindrical lens so as to expand the beam diameter only in the direction perpendicular to the groove direction of the diffraction grating 1. However, when the beam diameter expanding optical system is formed from either of the above-described lens systems, it is necessary to make the focal points of the two lenses coincident with each other. Therefore, the requirement for positioning becomes even stricter. In contrast, the magnifying prism optical system 5 has the advantage that such positioning is not needed. It should be noted that when an optical system for expanding the beam diameter in a one-dimensional direction is used, the direction in which the beam is expanded is set in a direction perpendicular to the groove direction of the diffraction grating 1.

The collimating optical system and the imaging optical system may be formed from a reflecting optical system, e.g. a concave mirror, in place of the refracting lens.

Further, in the foregoing embodiment, the spectrum dispersed by the diffraction grating 1 is detected by using the line sensor 4 having photodetector elements arrayed in the dispersion direction. However, the line sensor 4 may be replaced with a two-dimensional array sensor having micro photodetector elements arranged in a planar configuration. Furthermore, the arrangement may be such that an exit slit is positioned in the back focal plane of the imaging lens 2 so that light passing through the exit slit is detected with a photodetector, and the diffraction grating 1 or the exit slit is subjected to wavelength scanning as in a monochromator.

When the spectroscope is used to measure the spectral distribution of an ArF excimer laser beam or F₂ laser beam, it is desirable that the wavefront distortion for He—Ne laser light of the diffraction grating 1 be λ/10 or less (λ: wavelength) in the surface. Similarly, it is desirable that the transmission wavefront distortion of the magnifying prisms 5₁ to 5₃ be λ/10 or less in the surface. It should be noted that when light to be measured is an ArF excimer laser beam or F₂ laser beam, the vitreous material of the magnifying prisms 5₁ to 5₃ should preferably be calcium fluoride as shown in the numerical example. In such a case, it is desirable that the entrance and exit surfaces of the magnifying prisms 5₁ to 5₃ be provided with AR coating (antireflection film) against the wavelength of such a laser beam.

Although in the foregoing embodiment the angle of incidence on the magnifying prisms 5₁ to 5₃ is 73° and the angle of emergence therefrom is 0°, it should be noted that the angle of incidence may be set within the range of 72° to 76°, and the angle of emergence may be set in the vicinity of 0°.

Regarding the focal length f of the collimating optical system and the beam diameter magnifying power M of the beam diameter-expanding optical system, it is desirable to satisfy the following condition:

15(m)<f×M (2)

The lower limit of the above-described condition is a value that gives the minimum reciprocal linear dispersion required for the analysis of laser light having a spectral line shape with a spectral linewidth of 0.6 pm in terms of the full width at half maximum in a spectroscope using an echelle grating [e.g. see “Optronics” (1988) No. 3, pp. 124-130].

Although the spectral distribution measuring spectroscope according to the present invention has been described above on the basis of embodiments, it should be noted that the present invention is not limited to the foregoing embodiments but can be modified in a variety of ways.

As will be clear from the foregoing description, in the spectral distribution measuring spectroscope according to the present invention, a beam diameter-expanding optical system is placed at least between the collimating optical system and the diffraction grating to expand the diameter of the beam of light collimated by the collimating optical system at least in the direction of dispersion of the diffraction grating. Therefore, it is possible to obtain the same effect as that produced when the focal length of the collimating optical system increases by an amount corresponding to the beam diameter magnifying power of the beam diameter-expanding optical system, without increasing the focal length of the collimating optical system. Thus, the resolution can be improved to an extent corresponding to the beam diameter magnifying power. Accordingly, it becomes possible to realize a high-resolution spectroscope with a size approximately equal to that of the conventional apparatus without upsizing the system configuration. If an echelle grating is used as the diffraction grating, it is possible to carry out measurement with a high S/N ratio because the intensity of light is 40% or more even at a diffraction angle of 70° or more.

What we claim is:

1. A spectroscope for measuring a spectral distribution, comprising:
an entrance slit;
a collimating optical system for collimating light under measurement passing through said entrance slit;
a diffraction grating on which the light collimated by said collimating optical system is incident and which diffracts the light at angles of diffraction differing depending on wavelengths;
an imaging optical system for focusing a beam of light diffracted by said diffraction grating; and
one of an exit slit and a light distribution detector placed in a focal plane of said imaging optical system;
wherein said diffraction grating is a reflection type diffraction grating, and said collimating optical system also serves as said imaging optical system,
wherein a beam diameter-expanding optical system is placed at least between said collimating optical system and said diffraction grating to expand a diameter of a beam of light collimated by said collimating optical system at least in a direction of dispersion of said diffraction grating.

2. A spectroscope for measuring a spectral distribution according to claim 1, wherein said beam diameter-expanding optical system includes one or a plurality of magnifying prisms.

3. A spectroscope for measuring a spectral distribution according to claim 1 or 2, wherein said beam diameter-expanding optical system includes a plurality of magnifying prisms, all the magnifying prisms being positioned to face in a same direction, and said diffraction grating is mounted in a near-Littrow configuration so that one end of said diffraction grating is closer to an apex angle side of each of said magnifying prisms.

4. A spectroscope for measuring a spectral distribution according to any one of claims 1 to 3, wherein the following condition is satisfied:
15(m)<f×M (2)
where f is a focal length of said collimating optical system, and M is a beam diameter magnifying power of said beam diameter-expanding optical system.

5. A spectroscope for measuring a spectral distribution according to any one of claims 1 to 4, wherein said diffraction grating is an echelle grating.

6. A spectroscope for measuring a spectral distribution according to any one of claims 1, 3 and 4, wherein said diffraction grating is a near-Littrow mounted echelle grating, and said imaging optical system comprises three magnifying prisms,
wherein an angle of incidence on each of said magnifying prisms is in a range of from 72° to 76°, and an angle of emergence therefrom is 0° or in a vicinity of 0°.

7. A spectroscope for measuring a spectral distribution according to any one of claims 1 to 6, wherein said light distribution detector is one of a linear sensor having micro photodetector elements arranged linearly and a two-dimensional array sensor having micro photodetector elements arranged in a planar configuration.

8. A spectroscope for measuring a spectral distribution according to any one of claims 1 to 7, wherein a deflection mirror is placed in front of said light distribution detector.
